(19) United States
(12) Patent Application Publication
(10) Pub. No.: US 2008/0175191 A1
(43) Pub. Date: Jul. 24, 2008

(54) Method, Intermediate Station and Central Control Unit For the Packet-Switched Data Transmission in a Self-Organizing Radio Network

(75) Inventor: Sebastian Obermanns, Bocholt (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT

(21) Appl. No.: 10/590,138

(22) PCT Filed: Aug. 13, 2004
(86) PCT No.: PCT/EP04/51787

§ 371 Date: Aug. 22, 2006

(30) Foreign Application Priority Data
Feb. 23, 2004 (JP) 2004-046877

(51) Int. Cl. H04Q 7/00

(52) U.S. Cl. 370/329

(57) ABSTRACT

A method for the packet-switched data transmission in a self-organizing local radio network which has at least one first and one second radio coverage area and at least one mobile communication device per radio coverage area. In the first radio coverage area, a first device, and in the second radio coverage area, a second device are operated for the central control of the assignment of transmission channels associated with the respective radio coverage area. A mobile communication device in the first and in the second radio coverage area is operated as an intermediate station for forwarding data originating from the first radio coverage area to the second radio coverage area. The data are forwarded in such a manner that the first central control device controls the transmission channels available for the first radio coverage area both for data transmission between the first central control device and the intermediate station and for data transmission between the intermediate station and the second central control device. An intermediate station and a central control device are configured for carrying out the inventive method.

The invention relates to a method for the transmission of data in a self-organizing radio network in accordance with the preamble of claim 1, an intermediate station in accordance with claim 8 and a central control device in accordance with claim 9.

It is known that the stations in a local network (LAN) are generally linked to each other via cables. However, networks of this type are increasingly being replaced, or at least supplemented, by radio networks which function, for example, according to the WLAN standard (IEEE 802.11).

Radio networks of this type can in principle be divided, according to the nature of the medium access method used, into decentralized networks, for example a network which employs the “Distributed Coordinated Function (DCF)” in accordance with IEEE 802.11, and centralized networks, for example structured in accordance with the Hiperlan/2 or Bluetooth standard.

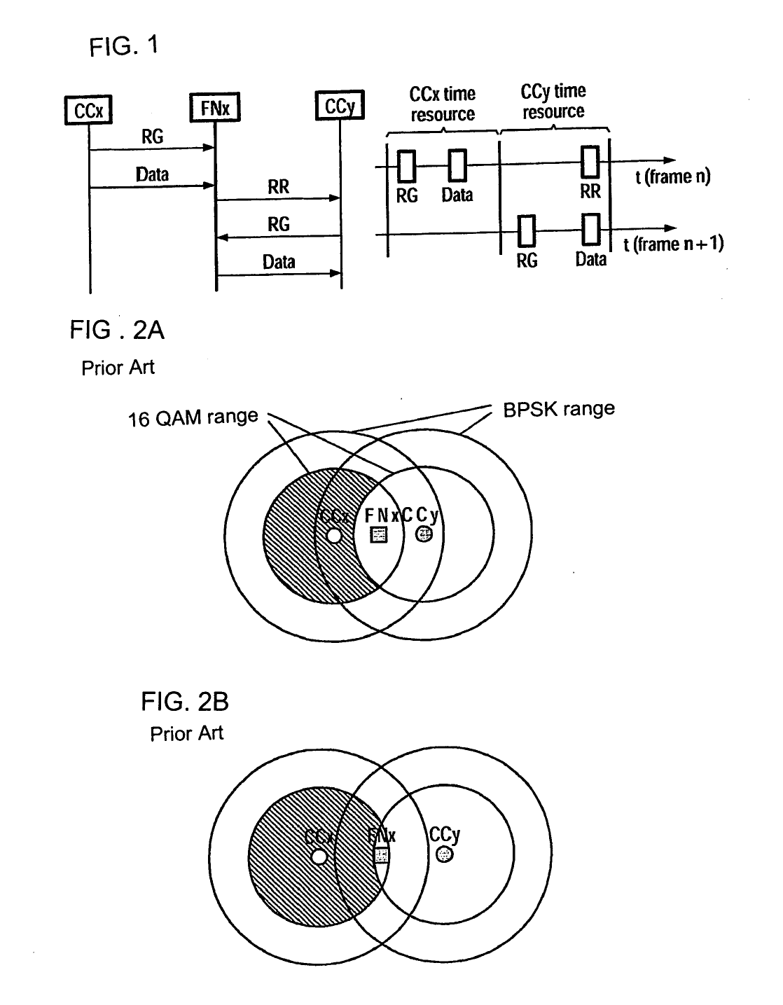

In a central network, a radio coverage area (cluster) is provided with a central control unit (central controller) which regulates access to the resources (transmission medium or medium) by the stations located within the radio coverage area. For example, as shown in FIG. 1, a transmission of data by a station within the cluster does not take place until the station has been informed by the central controller of the resource to be used, whereby under Hiperlan/2 this takes place in such a way that all the stations which wish to transmit first transmit a so-called “Resource Request” (RR) to the central controller, which for the purpose of authorizing the data transmission then communicates to the station concerned a “Resource Grant” (RG) within a transmission frame defined in accordance with the radio interface. The central controller also indicates its own data transmissions with an RG in the same MAC frame. In accordance with the Hiperlan/2 standard, the RG messages contain items of control data for the data transmission. In both cases, these are essentially the identifications of the transmitter and receiver, a link identification, number and nature of the transport channels, time point for the start of the transmission, and the nature of the encoding and modulation schema to be used on the physical layer. “Resource Grant” messages are transmitted by the central controller at the start of the MAC frame via the so-called “Frame Channel” (FCH).

From “J. Habetha and M. Nadler, Concept of a wireless centralised multihop ad hoc network”, in “Proc. European Wireless, Dresden, September 2000”, it is also known that a centralized Hiperlan/2 network consists of several clusters, each of which has a central controller. A network extended in this way, from one cluster to several clusters, is referred to as a so-called multi-cluster network, and takes a form such that the central controllers control access to the media independently of each other, this being achieved by a reuse factor of greater than 1, where the term “Reuse Factor” refers to the distance between radio coverage areas at which the resources used, i.e. in general the frequencies which are available, recur.

With a derivative of the system described above, it is also possible to allocate to the central control units of the clusters, as the resources to be administered, non-overlapping periodic time intervals on one single frequency, rather than different frequencies.

In this situation, it is advantageous to subdivide the transmission bandwidth into as few resources as possible, which can be achieved by the distances between the central controllers being large, wherever possible. For this purpose, because of the distance, an advantageous requirement for the exchange of data between any two neighboring radio coverage areas is intermediate stations (forwarding nodes) located in the area where the radio coverage areas overlap, and which can therefore be assigned to two clusters.

A disadvantage of the networks described is that the transmission of data between two clusters which are far apart involves several intermediate stations and central controllers, which therefore occupies their resources, and in addition a delay occurs due to the resource allocation methods for the intermediate stations involved, as can be seen from the data flow shown in FIG. 1.

The object underlying the invention is to specify a method which makes possible the efficient exchange of data in a self-organizing multi-cluster network.

This object is achieved, starting from the method for data transmission in a self-organizing radio network in accordance with the preamble of claim 1, by its characterizing features, by the intermediate station in accordance with the characteristics of claim 8, and by the central control unit in accordance with the characteristics of claim 9.

With the method in accordance with the invention for packet-switched data transmission in a self-organizing radio network, with at least one first and one second radio coverage area, together with at least one mobile communication device for each radio coverage area, whereby a first device is operated in the first radio coverage area, and a second device in the second radio coverage area, for the purpose of central control of the assignment of the transmission channels assigned to the radio coverage area concerned, and mobile communication devices are operated both in the first and also in the second radio coverage area as intermediate stations, for forwarding to the second radio coverage area data originating in the first radio coverage area, where the forwarding takes place in such a way that the first central control device controls the transmission channels available to the first radio coverage area, both for transmission of data between the first central control device and the intermediate station and also for the transmission of data between the intermediate station and the second central control device.

The result of the method in accordance with the invention is that any delay to the transmission of data packets, arising from their being forwarded, is minimized. Apart from any other effects of the method in accordance with the invention, intermediate stations can be more simply operated. In addition, in contrast to methods known from the prior art, a packet which is to be transmitted to a remote radio coverage area need in each case only be processed once by the packet scheduler of the central control unit. Because the first central control unit controls the assignment of resources both for the (partial) transmission of a data packet to the intermediate station and also for the (partial) transmission to the next reachable second control unit, the number of requests and answers for the purpose of assigning resources is reduced, so that the available resources are more efficiently used. A further concentration of functions onto the central control unit is also achieved, so that those communication terminal devices which are operated as intermediate stations are freed of additional tasks, and need provide less complex functions.

Preferably, the control data which is appended will be transmitted on a separate transmission channel, in particular an FCH channel, if it can be ensured that the second control unit can receive the first control unit's FCH channel. This renders it unnecessary to add content to the data which is to be forwarded. In addition, significantly fewer intermediate stations are involved, because the control data can be decoded directly by a receiving central control device. Control channels of this type can have encoding which is more robust in respect of transmission errors, for example “Binary Phase Shift Keying”, BPSK, so that control data which is transmitted on these control channels can be received over a greater radius. In this case payload data could in principle also be transmitted directly and just as robustly with no intermediate stations from the first to the second control unit. However, when an intermediate station is used the transmission can be more efficient in terms of the network resources occupied than with a direct transmission, if the split into two transmissions makes it possible to use higher quality encoding and modulation on both links.

Alternatively, if the FCH channel cannot be received by the second central control device, the intermediate station appends to the data which is to be forwarded the control data for the second central control device. This is particularly advantageous when the second central control device is not within radio range of the first central control device. In such a case, the items of control data added to the data can be forwarded by the intermediate station and decoded by the second central control device. By this means, the second control device is given further details about the data forwarded by the intermediate station, which puts it in a position to decode the data and receive it without errors.

This approach, of appending control data to the payload data channels, can also be used as an enhancement. For example, a development is conceivable by which, if the receipt of the FCH channel deteriorates due to an increase in the distance between the first central control device and the second central control device, or due to other influences, the first central control device instructs the intermediate station to forward the control data for the RG message via the payload data channel or, if there is an improvement in the reception situation, withdraws the instruction again.

In doing this, the control data in the RG message which describes the transmission (with the exception of the time point of the transmission) will preferably be appended to the data which is to be forwarded. By this means, the receiver of the data which is to be forwarded is defined. In addition, it contains for example notes on the encoding of the data, which enable the data decoding to be suitably adapted.

The data may, for example, not terminate in the radio coverage area of the second central control device, but this radio coverage area may represent simply a link in a connecting chain of radio coverage areas through to the data's destination. In such a case, the approach in accordance with the invention will be appropriately repeated, so that a cascade-like interaction through to the data's destination is realized.

Facilities for carrying out the method explained above are provided by the intermediate station in accordance with the invention, thus enabling an implementation of the method for establishing an improved communication system.

Facilities for carrying out the method explained above are provided by the central control device in accordance with the invention, thus enabling an implementation of the method for establishing an improved communication system.

Further advantages and details of the invention are explained by reference to the figures. These show:

FIG. 1 a data flow in accordance with the prior art,???

FIG. 2a CCx and CCy mutually within range (Case A),

FIG. 2b CCx and CCy out of each other's range (Case B),

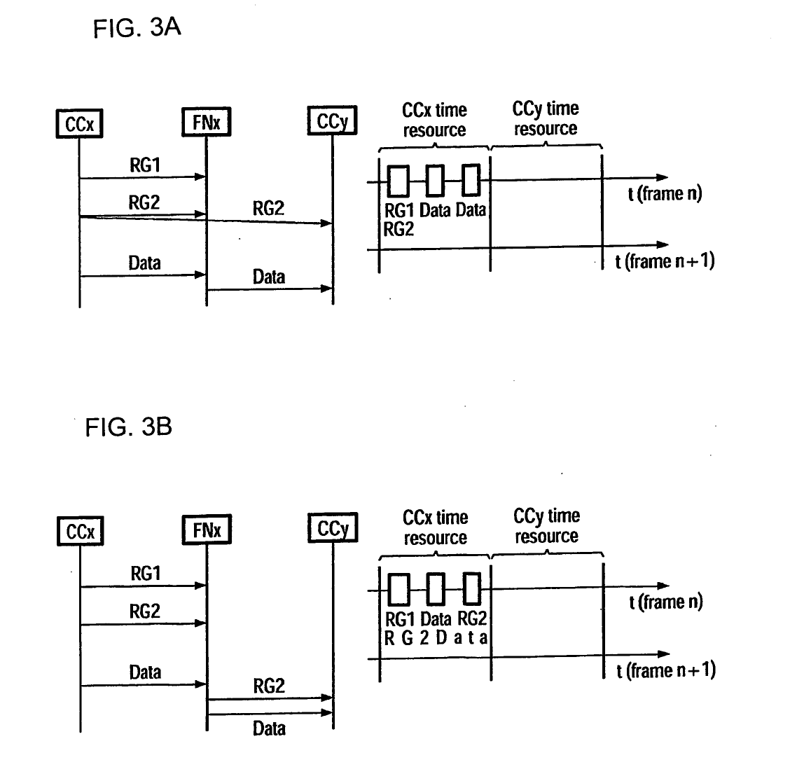

FIG. 3a a dependency on the effect of the signal sequence generated by the method in accordance with the invention for the arrangement shown in FIG. 2a,

FIG. 3b a dependency on the effect of the signal sequence generated by the method in accordance with the invention for the arrangement shown in FIG. 2b,

FIG. 1 shows a Medium Access Control data flow, as implemented in accordance with the prior art. It can be seen that for the forwarding of data DATA a sequence of data packets RR, RG are dispatched for the allocation of resources. This delays the forwarding of the data DATA, and in addition occupies payload data transmission resources.

FIG. 2a illustrates a model of a possible arrangement of a wireless communication system, as is also known in networks known from the prior art, and in which the method in accordance with the invention is employed. The illustration shows a first central control device CCX, an intermediate station FNX together with a second central control device CCY. Also to be seen are a first radio coverage area which is provided by the first central control device CCX and a second radio coverage area which is provided by the second central control device CCY, where the first and second central radio coverage areas have a range within which payload data can be exchanged with mobile terminal devices, and the ways of achieving which include the type of modulation or the encoding, as applicable—in the example this is 16 Quadrature Amplitude Modulation (16QAM).

Also to be seen are a third radio coverage area and a fourth radio coverage area, which have greater ranges than those of the first radio coverage area and the second radio coverage area due to the nature of the modulation used for transmission of the control data, that shown in the example being Binary Phase Shift Keying (BPSK).

For the exemplary embodiment shown, it can be seen that in respect of the transmission of control data each of the central control devices CCX, CCY is located within range of the other control device. The BPSK channel provided for the transmission of the control data, designated FCH in accordance with the exemplary embodiment, can thus be used in accordance with the invention in such a way that control data, such as for example the receiving address and the format of data which is to be forwarded, is transmitted directly, from the first central control device CCX to the second central control device CCY and in the reverse direction. Further forwarding to a third central control device (not shown) can then be initiated from the second central control device CCY. By such a connection from one to another (cascading) of forwarding activities, realized in accordance with the invention, even very large distances can be spanned. Because the items of control data are transmitted directly to each of the control devices involved, the intermediate stations involved can be operated, without extensive changes, in accordance with the inventive method, and the main content of the modifications required in connection with the implementation of the method lies in the central control devices.

An alternative arrangement is illustrated in FIG. 2b. The arrangement shown contains elements which are already known from the previous arrangement, and which are therefore labeled with the same reference characters. It can be seen that the first central control device CCX and the second central control device CCY can no longer communicate with each other via control data channels. Only the intermediate station FNX is, as before, located within range for a data transmission on payload data channels, both toward the first central control device and also toward the second central control device CCY.

It is of advantage for the arrangement described if, in accordance with the invention, the control data RG2 (see FIG. 2) is attached to the data to be forwarded (shown as Case B in FIG. 2), so that the second central station CCY can decode and analyze it, in order to be able to transport the data which is to be forwarded to the desired destination.

With the arrangement shown, the second central control device CCY must be able, at arbitrary times which are outside the time resources assigned to the second central control device CCY, to detect the transmissions which are part of a forwarding activity. This is achieved by a special burst format. Here, it should be noted that, because of the separation in the time domain between the radio coverage areas, the second central control device CCY can receive the data forwarded by the first central control device CCX and/or by the intermediate station FNX.

The main advantageous effect of the method in accordance with the invention can be seen from FIG. 3a, which shows a Medium Access Control data flow resulting in accordance with the invention.

It can be seen that data DATA which is to be forwarded is transmitted from the first central control device CCX to the intermediate station FNX, and from there without delay to the second central control device CCY. This happens because, by comparison with the data flow in accordance with the prior art, described and shown above, due to the method in accordance with the invention no resource request queries, which are generally offset in time relative to the data DATA, arise.

This also has the advantage that the available resources are not occupied by messages of this type.

Also shown is the use of resources in the case of forwarding in accordance with the inventive method. It can be seen that the data DATA to be forwarded comes to the second central control device CCY in the time resource of the radio coverage area provided by the first central control unit CCX.

Apart from the advantages already explained, this also avoids entering packets into transmission queues. In addition, intermediate stations are freed of IP router functions, which leads to a further reduction in the complexity of the intermediate stations.

1-9. (canceled)

10. A method for packet-switched data transmission in a self-organizing radio network with at least a first and a second radio coverage area, and at least one mobile communication device for each radio coverage area, which comprises:
operating a first device in the first radio coverage area and a second device in the second radio coverage area, for centrally controlling an assignment of transmission channels assigned to the respective radio coverage area;
operating in each of the first and second radio coverage areas mobile communication devices forming intermediate stations for forwarding to the second radio coverage area data originating from the first radio coverage area; and
thereby operating the first central control device to control the transmission channels available to the first radio coverage area, both for transmitting data between the first central control device and the intermediate station and for transmitting data between the intermediate station and the second central control device.

11. The method according to claim 10, which comprises transmitting control data appended in the transmission with the first central control device on a separate transmission channel.

12. The method according to claim 11, wherein the separate transmission channel is an FCH channel.

13. The method according to claim 12, which comprises, if the FCH channel cannot be received by the second central control device, appending with the intermediate station control data for the second central control device to the data to be forwarded.

14. The method according to claim 10, which comprises adding to the control data at least one of an address of the second central control device and a format of the data to be forwarded.

15. The method according to claim 10, which comprises analyzing the control data in the intermediate station.

16. The method according to claim 10, which comprises analyzing the control data in the second central control device.

17. The method according to claim 10, which comprises operating the radio network using central medium access control in accordance with a standard selected from the group consisting of IEEE 802.11 standard, IEEE 802.16, Hiperlan/2, and a standard derived therefrom.

18. An intermediate station configured for carrying out the method according to claim 10.

19. A central control device configured for carrying out the method according to claim 10.
